(19) United States
(12) Patent Application Publication
(10) Pub. No.: US 2022/0389873 A1
(43) Pub. Date: Dec. 8, 2022

(54) GEARBOX AND GAS TURBINE PROPULSION UNIT

(71) Applicant: Rolls-Royce Deutschland Ltd & Co KG, Blankenfelde-Mahlow (DE)

(72) Inventors: Stephan UHKOETTER, Berlin (DE); Stefan MENCZYKALSKI, Berlin (DE)

(21) Appl. No.: 17/621,388

(22) PCT Filed: Jun. 23, 2020
(86) PCT No.: PCT/EP2020/067455

§ 371 Date: Aug. 15, 2022

(30) Foreign Application Priority Data
Jun. 24, 2019 (DE) 10 2019 116 974.7

(51) Int. Cl. F02C 7/36; F16H 57/04

(52) U.S. Cl. CPC F02C 7/36; F16H 57/0456; F16H 57/0482; F05D 2220/36; F05D 2260/205; F05D 2260/98; F05D 2260/40311

(57) ABSTRACT

The invention describes a transmission (30) having a rotatably mounted component (34) that is designed with at least two approximately rotationally symmetrical channels (41, 141) into which oil from a respective oil supply (44, 144) fixed to the housing can be introduced proceeding from the respective radially inner region (42, 142) of said channels. In at least one radially outer region (45, 145), the channels (41, 141) each have at least one outlet opening (46, 146) for the oil. Furthermore, the oil can be conveyed from the outlet openings (46, 146) to at least one hydraulic consumer via at least one line region (47, 147) in each case. A gas turbine engine having the transmission (30) is also proposed.

The present disclosure relates to a transmission with a rotatably mounted component which is designed with at least two rotationally symmetrical channels. The present disclosure furthermore relates to a gas turbine engine for an aircraft.

A transmission of a jet engine is known in practice. The transmission comprises a sun gear, a ring gear that is fixed to the housing, and a rotatable planet carrier via which a fan can be driven. A plurality of planet gears engage with the sun gear and the ring gear. Oil is guided in the direction of tooth engagements between the planet gears and the ring gear via a catchment channel which is connected to the planet carrier of the transmission. The catchment channel extends in the circumferential direction of the planet carrier, and is designed to be open on the radial inside. Oil is introduced from a supply via the radially inner opening.

A transmission and a gas turbine engine with a transmission are provided, in which the oil supply to a rotatable component of the transmission is guaranteed.

This object is achieved by means of a transmission and a gas turbine engine having the features of claims 1 and 16 respectively.

According to a first aspect, a transmission is provided with a rotatably mounted component which is designed with at least two channels which are at least approximately rotationally symmetrical. Starting from the radially inner regions of the channels, oil can be conducted into the channels from oil supplies fixed to the housing. In at least one radially outer region, the channels each have at least one outlet opening for the oil. Through this, oil in the channels is flung in the direction of the outlet openings by the centrifugal force acting on the oil during rotation of the component, and from there transferred in the necessary fashion in the direction of the region of the transmission to be loaded with oil, such as a bearing and/or a toothing. The oil may here be conveyed from the outlet openings to at least one hydraulic consumer via at least one respective line region.

This solution offers, in a simple fashion, the possibility of being able to load a hydraulic consumer with oil via different oil circuits, and guarantee an oil supply even in the case of a fault in the region of one of these oil circuits.

In further embodiments of the transmission according to the present disclosure, supply line cross-sections of the oil supplies correspond to or differ from one another.

Furthermore, radial depths of the channels may correspond to or differ from one another.

If cross-sections of the line regions correspond to one another, then with little structural complexity, the oil volume flows which can be supplied to a hydraulic consumer from the channels are substantially equal.

If cross-sections of the line regions differ from one another, then with little structural complexity, the oil volume flows which can be supplied to a hydraulic consumer from the channels can be set substantially differently.

In further embodiments of the transmission according to the present disclosure, the lengths of the line regions differ from or correspond to one another.

The line regions comprise opening regions which are each arranged in the region of hydraulic consumers of the planetary gear mechanism, and via which the hydraulic consumers can be loaded with oil.

It may be provided that radial distances between the opening regions and a rotational axis of the component are each larger and/or smaller than radial distances between the outlet openings of the channels and the rotational axis. Furthermore, it is also possible that the radial distances between the opening regions and the rotational axis of the component are the same as the radial distances between the outlet openings of the channels and the rotational axis.

If the radial distances between the opening regions and a rotational axis of the component are each greater than radial distances between the outlet openings of the channels and the rotational axis, then the oil conducted into the respective channels will also be accelerated downstream of the outlet openings up to the opening regions by the centrifugal force acting in operation, or be conveyed through the channels and the line regions to the respective hydraulic consumers to be supplied.

Depending on the installation space available in each case, the channels may be arranged on the same side of the component or at least one of the channels may be arranged on one side of the component, and at least one further of the channels is arranged on a side lying opposite thereto in an axial extent of the component.

It is possible that the infeed directions of the oil into the channels, starting from the oil supplies, each enclose an angle of between 45° and 135° with the axial extent direction of the channels.

In addition, it may be provided that the infeed directions of the oil in the circumferential direction of the channels each enclose an angle which is greater than 0° and less than 90° with the radial extent direction of the channels.

Infeed directions of the oil into the channels, starting from the oil supplies, may each enclose an angle of 90° with the axial extent direction of the channels, whereby oil is conducted into the channels substantially in the radial extent direction thereof.

In this way, on infeed from the oil supplies into the channel, the oil is given an impulse such that the oil in the channels is accelerated to an extent necessary for transfer thereof in the direction of for example a bearing of the rotatable component, and a sub-supply to a bearing or tooth engagements between components of the transmission can be avoided.

In the present case, the term “channel” means an outer, wall-like boundary which delimits an inner region which is channel-like at least in regions. The boundary itself, independently of fittings arranged in the inner region of the boundary, is designed to be at least approximately rotationally symmetrical.

Furthermore, the infeed directions of the oil into the channels, starting from the oil supplies, may each enclose an angle of between 75° and 90°, preferably between 80° and 90°, with the axial extent direction of the channels. If the infeed directions of the oil each enclose an angle with the axial extent direction of the channels which lies within the latter angular ranges, oil is again given an impulse on infeed into the channels. This impulse guarantees that the oil in the channels is accelerated to an extent necessary for transfer thereof in the direction of for example a bearing of the rotatable component, and a sub-supply to the bearing or tooth engagements between components of the transmission can be avoided.

According to a further aspect of the present disclosure, the component is a rotating shaft, preferably a sun gear, a planet carrier, a planet gear and/or a ring gear. Then for example a bearing or tooth engagement of a planetary gear mechanism can be supplied with oil to the necessary extent in a structurally simple fashion, and reliable and secure operation of the entire transmission can be guaranteed.

In particular in the case of circulating planet gears, a transfer from the stationary system to the planet gears rotating around the sun gear of the gear mechanism is thus guaranteed.

The oil supplies may each comprise at least one oil nozzle, the outlet openings of which are spaced radially and/or axially from inlet openings for the oil provided in radially inner regions of the channels.

If, in each case, at least one oil nozzle is provided which is arranged centrally within the radially inner regions of the channels in the installation position of the transmission, then with little complexity, on infeed into the channels, the oil can be given an impulse necessary for an adequate oil supply to consumers in the transmission.

If, in each case, at least two oil nozzles are provided which are each arranged between one of the channels and a rotational axis of one of the channels, and centrally within the radially inner region of a channel, then the oil may be given an impulse necessary for an adequate oil supply to consumers in the transmission.

The present disclosure provides a non-closed oil transfer unit which is characterized by a self-adjusting system of optional nozzles arranged over the periphery. Lubricant and coolant may be sprayed into rotating channels or grooves via the oil nozzles. Because of centrifugal force, supply pressures are built up within the rotating catchment grooves and the following distribution lines. The non-closed system comprising oil nozzles and catchment channels allows the possibility of different fluid levels in the rotating system. The supply pressures in the rotating system again depend on the oil levels set. The result is a self-adjusting and robust supply system via which the consumers are supplied in a fashion entailing significantly less dependence on counter-pressures.

If the counter-pressures, i.e. the respective prevailing pressure in the consumer and the pressure losses up to the consumer, lie within an acceptable pressure range and are accordingly not excessively small or large, the adjustment may take place via the fluid level in the rotating supply lines. As the oil volume flow rises, the supply pressure rises, and more oil is pressed in the direction of a consumer such as a bearing. In the reverse case, the supply pressures fall as the volume flows fall. A respective suitable counter-pressure prevents evacuation of the oil system, and instead a reduced but continuous supply takes place.

The transmission proposed here comprises oil transfer units without wearing parts in the form of contact seals. Furthermore, the transmission may comprise a self-adjusting system with oil nozzles arranged around the periphery of the channels, via which the lubricant and coolant or oil is sprayed into rotating catchment channels, usually grooves.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure can be particularly, although not exclusively, beneficial for fans that are driven via a transmission. Accordingly, the gas turbine engine may comprise a transmission which receives an input from the core shaft and provides drive for the fan, so as to drive the fan at a lower rotational speed than the core shaft. The input to the transmission may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed). The transmission herein may be configured as a transmission as has been described in more detail above.

The gas turbine engine as described and claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, second compressor and second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The transmission may be arranged so as to be driven by that core shaft (for example the first core shaft in the example above) which is configured to rotate (for example during use) at the lowest rotational speed. For example, the transmission may be arranged so as to be driven only by that core shaft (for example only by the first core shaft, and not the second core shaft, in the example above) which is configured to rotate (for example during use) at the lowest rotational speed. Alternatively thereto, the transmission may be arranged so as to be driven by one or a plurality of shafts, for example the first and/or the second shaft in the example above.

In the case of a gas turbine engine which is described and claimed herein, a combustion chamber may be provided so as to be axially downstream of the fan and the compressor(s). For example, the combustion chamber can lie directly downstream of the second compressor (for example at the exit of the latter), if a second compressor is provided. By way of further example, the flow at the exit of the compressor may be supplied to the inlet of the second turbine, if a second turbine is provided. The combustion chamber may be provided upstream of the turbine(s).

The or each compressor (for example the first compressor and the second compressor as described above) may comprise any number of stages, for example multiple stages. Each stage may comprise a row of rotor blades and a row of stator vanes, the latter potentially being variable stator vanes (in that the angle of incidence of said stator vanes can be variable). The row of rotor blades and the row of stator blades may be axially offset from one another.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset from one another.

Each fan blade may be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip may be less than (or of the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios may be referred to in general as the hub-to-tip ratio. The radius at the hub and the radius at the tip can both be measured at the leading periphery part (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centerline and the tip of the fan blade at the leading periphery of the latter. The diameter of the fan (which can simply be double the radius of the fan) may be larger than (or of the order of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range from 250 cm to 300 cm (for example 250 cm to 280 cm) may also be in the range from 1700 rpm to 2500 rpm, for example in the range from 1800 rpm to 2300 rpm, for example in the range from 1900 rpm to 2100 rpm. Purely by way of a further non-limiting example, the rotational speed of the fan under cruise conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a velocity Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) velocity of the fan tip, for example at the leading periphery of the tip (which can be defined as the fan tip radius at the leading periphery multiplied by the angular velocity). The fan tip loading at cruise conditions may be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range delimited by two of the values in the previous sentence (that is to say that the values may form upper or lower limits).

Gas turbine engines in accordance with the present disclosure can have any desired bypass ratio, wherein the bypass ratio is defined as the ratio of the mass flow rate of the flow through the bypass duct to the mass flow rate of the flow through the core at cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in an inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and claimed herein may be defined as the ratio of the stagnation pressure upstream of the fan to the stagnation pressure at the exit of the highest pressure compressor (before the entry to the combustion chamber). By way of non-limiting example, the overall pressure ratio of a gas turbine engine as described and claimed herein at cruising speed may be greater than (or of the order of): 35, 40, 45, 50, 55, 60, 65, 70, 75. The overall pressure ratio may be in an inclusive range delimited by two of the values in the previous sentence (that is to say that the values may form upper or lower limits).

The specific thrust of a gas turbine engine may be defined as the net thrust of the gas turbine engine divided by the total mass flow through the engine. The specific thrust of an engine as described and/or claimed herein at cruise conditions may be less than (or of the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range delimited by two of the values in the previous sentence (that is to say that the values may form upper or lower limits). Such gas turbine engines can be particularly efficient in comparison with conventional gas turbine engines.

A gas turbine engine as described and claimed herein may have any desired maximum thrust. Purely by way of a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15 degrees C. (ambient pressure 101.3 kPa, temperature 30 degrees C.) in the case of a static engine.

During use, the temperature of the flow at the entry to the high-pressure turbine can be particularly high. This temperature, which can be referred to as TET, may be measured at the exit to the combustion chamber, for example directly upstream of the first turbine blade, which in turn can be referred to as a nozzle guide vane. At cruising speed, the TET may be at least (or of the order of): 1400 K, 1450 K, 1500 K, 1550 K, 1600 K, or 1650 K. The TET at cruising speed may be in an inclusive range delimited by two of the values in the previous sentence (that is to say that the values may form upper or lower limits). The maximum TET in the use of the engine may be at least (or of the order of), for example: 1700 K, 1750 K, 1800 K, 1850 K, 1900 K, 1950 K, or 2000 K. The maximum TET may be in an inclusive range delimited by two of the values in the previous sentence (that is to say that the values may form upper or lower limits). The maximum TET may occur, for example, under a high thrust condition, for example under a maximum take-off thrust (MTO) condition.

A fan blade and/or an airfoil portion of a fan blade as described herein can be manufactured from any suitable material or a combination of materials. For example, at least a part of the fan blade and/or of the airfoil can be manufactured at least in part from a composite, for example a metal matrix composite and/or an organic matrix composite, such as carbon fiber. By way of further example, at least a part of the fan blade and/or of the airfoil can be manufactured at least in part from a metal, such as a titanium-based metal or an aluminum-based material (such as an aluminum-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbon-fiber-based or aluminum-based body (such as an aluminum-lithium alloy) with a titanium leading periphery.

A fan as described herein may comprise a central portion from which the fan blades can extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of further example, the fan blades can be formed integrally with a central portion. Such an arrangement may be referred to as a blisk or a bling. Any suitable method may be used to manufacture such a blisk or such a bling. For example, at least some of the fan blades can be machined from a block and/or at least some of the fan blades can be attached to the hub/disk by welding, such as linear friction welding, for example.

The gas turbine engines as described and claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine engine as described and claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or the gas turbine engine at the midpoint (in terms of time and/or distance) between end of climb and start of descent.

Purely by way of example, the forward speed at the cruise condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example in the magnitude of Mach 0.8, in the magnitude of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example of the order of 11,000 m. The cruise conditions may correspond to standard atmospheric conditions at any given altitude in these ranges.

Purely by way of example, the cruise conditions may correspond to the following: a forward Mach number of 0.8; a pressure of 23,000 Pa; and a temperature of −55 degrees C.

As used anywhere herein, “cruising speed” or “cruise conditions” may mean the aerodynamic design point. Such an aerodynamic design point (or ADP) may correspond to the conditions (including, for example, the Mach number, environmental conditions, and thrust requirement) for which the fan operation is designed. This may mean, for example, the conditions under which the fan (or the gas turbine engine) has the optimum efficiency in terms of construction.

During use, a gas turbine engine as described and claimed herein can operate at the cruise conditions defined elsewhere herein. Such cruise conditions can be determined by the cruise conditions (for example the mid-cruise conditions) of an aircraft to which at least one (for example 2 or 4) gas turbine engine can be fastened in order to provide the thrust force.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

Embodiments will now be described, by way of example, with reference to the figures.

in which:

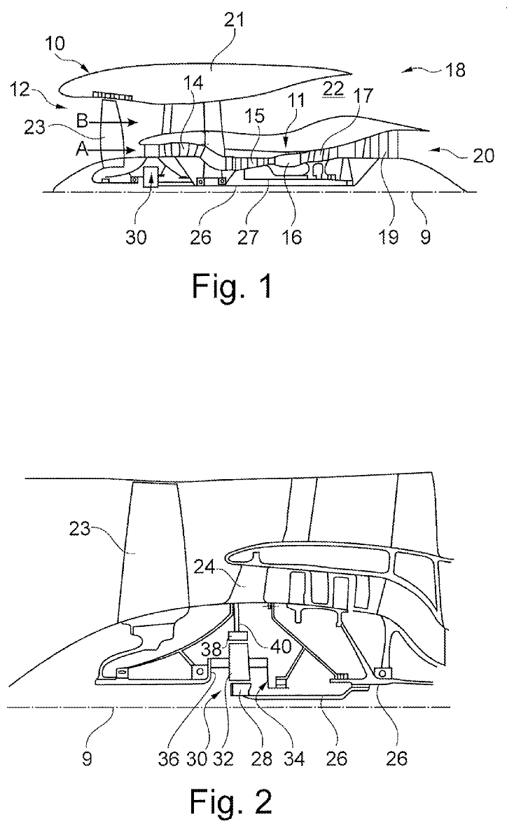

FIG. 1 shows a longitudinal sectional view of a gas turbine engine;

FIG. 2 shows an enlarged partial longitudinal sectional view of an upstream portion of a gas turbine engine;

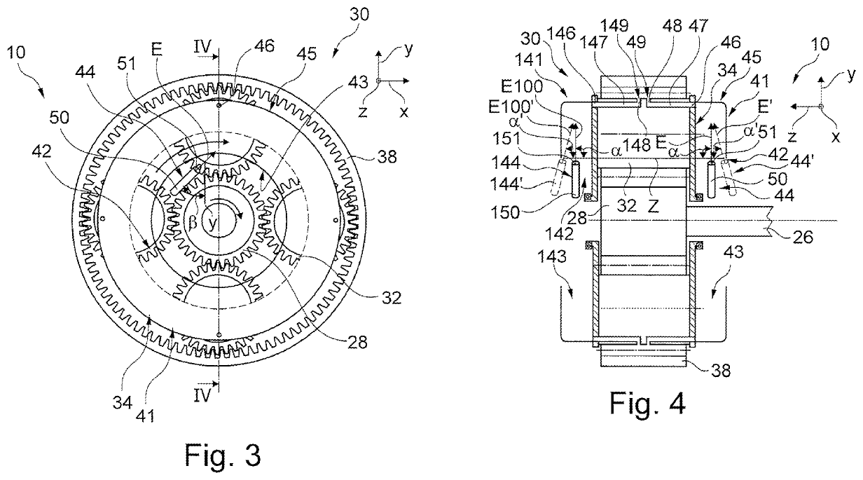

FIG. 3 shows an isolated illustration of a transmission for a gas turbine engine;

FIG. 4 shows a sectional view of an embodiment of the transmission along a section line IV-IV denoted more specifically in FIG. 3;

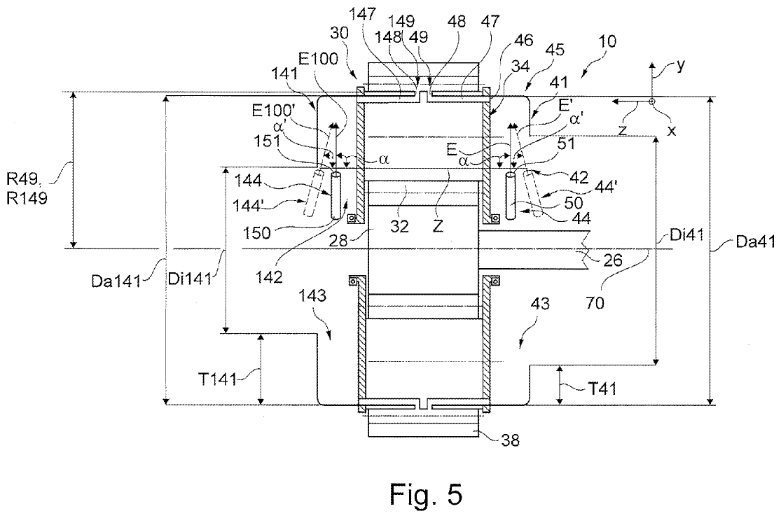

FIG. 5 shows an illustration corresponding to FIG. 4 of a further embodiment of the transmission;

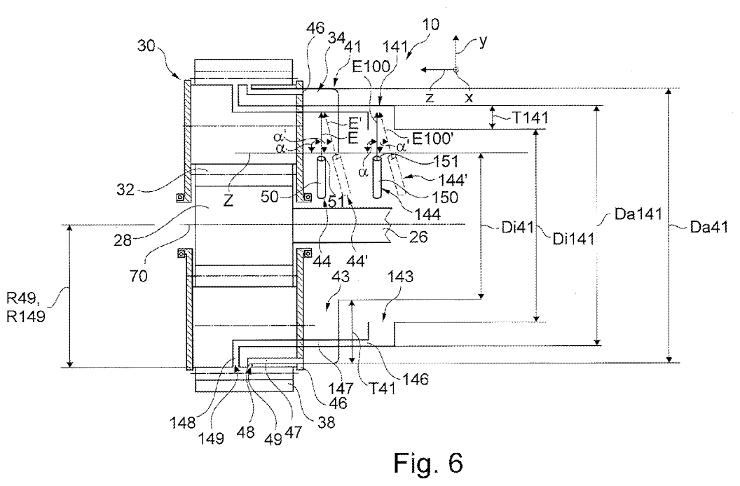

FIG. 6 shows an illustration corresponding to FIG. 4 of a further embodiment of the transmission;

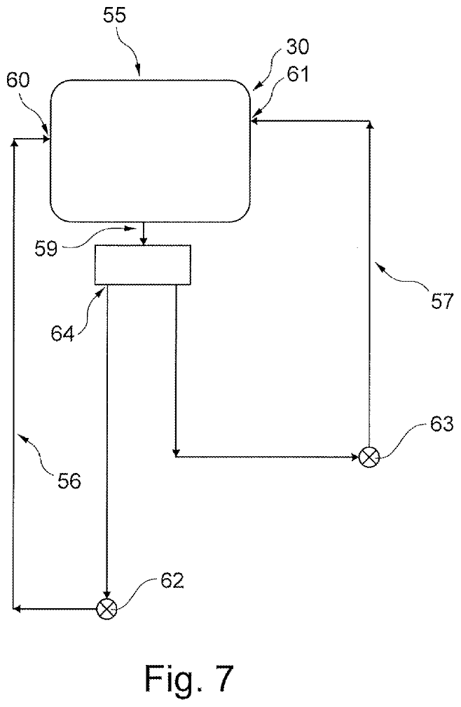

FIG. 7 shows a first embodiment of an oil circuit of the gas turbine engine from FIG. 1; and

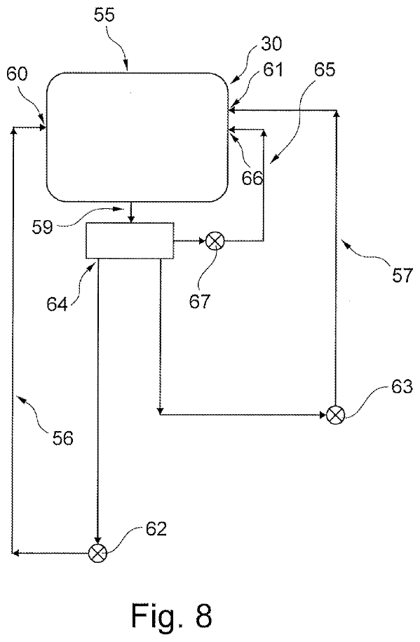

FIG. 8 shows an illustration corresponding to FIG. 7 of a second embodiment of the oil circuit.

FIG. 1 illustrates a gas turbine engine 10 with a main axis of rotation 9. The engine 10 comprises an air intake 12 and a thrust fan 23 that generates two airflows: a core airflow A and a bypass airflow B. The gas turbine engine 10 comprises a core 11 that receives the core airflow A. In the sequence of axial flow, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 by way of a shaft 26 and an epicyclic transmission 30. The shaft 26 herein is also referred to as the core shaft.

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before being expelled through the nozzle 20 to provide a certain propulsive thrust. The high-pressure turbine 17 drives the high-pressure compressor 15 by way of a suitable connecting shaft 27, which is also referred to as the core shaft. The fan 23 generally provides the majority of the propulsion force. The epicyclic transmission 30 is a reduction transmission.

An exemplary arrangement for a geared fan gas turbine engine 10 is shown in FIG. 2. The low-pressure turbine 19 (see FIG. 1) drives the shaft 26, which is coupled to a sun gear 28 of the epicyclic transmission arrangement 30. Multiple planet gears 32, which are coupled to one another by means of a planet carrier 34, are situated radially outside the sun gear 28 and mesh with the latter, and are in each case arranged so as to be rotatable on carrier elements 29 which are connected in a rotationally fixed manner to the planet carrier 34. The planet carrier 34 limits the planet gears 32 to orbiting around the sun gear 28 in a synchronous manner while enabling each planet gear 32 to rotate about its own axis on the carrier elements 29. The planet carrier 34 is coupled by way of linkages 36 to the fan 23 so as to drive the rotation of the latter about the engine axis 9. Radially to the outside of the planet gears 32 and meshing therewith is an annulus or ring gear 38 that is coupled, via linkages 40, to a stationary support structure 24.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the transmission output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

The epicyclic transmission 30 is shown in greater detail by way of example in FIG. 3. Each of the sun gear 28, the planet gears 32 and the ring gear 38 comprise teeth about their periphery to mesh with the other gears. However, for clarity, only exemplary portions of the teeth are illustrated in FIG. 3. Although four planet gears 32 are illustrated, it will be apparent to the person skilled in the art that more or fewer planet gears 32 may be provided within the scope of protection of the claimed invention. Practical applications of an epicyclic transmission 30 generally comprise at least three planet gears 32.

The epicyclic transmission 30 illustrated by way of example in FIGS. 2 and 3 is of the planetary type, in which the planet carrier 34 is coupled to an output shaft via linkages 36, wherein the ring gear 38 is fixed. However, any other suitable type of epicyclic transmission 30 can be used. By way of further example, the epicyclic transmission 30 can be a star arrangement, in which the planet carrier 34 is held so as to be fixed, wherein the ring gear (or annulus) 38 is allowed to rotate. In the case of such an arrangement, the fan 23 is driven by the ring gear 38. As a further alternative example, the transmission 30 can be a differential transmission in which both the ring gear 38 and the planet carrier 34 are allowed to rotate.

It will be appreciated that the arrangement shown in FIGS. 2 and 3 is merely exemplary, and various alternatives fall within the scope of protection of the present disclosure. Purely by way of example, any suitable arrangement can be used for positioning the transmission 30 in the engine 10 and/or for connecting the transmission 30 to the engine 10. By way of a further example, the connections (such as the linkages 36, 40 in the example of FIG. 2) between the transmission 30 and other parts of the engine 10 (such as the input shaft 26, the output shaft and the fixed structure 24) may have a certain degree of stiffness or flexibility. By way of a further example, any suitable arrangement of the bearings between rotating and stationary parts of the engine (for example between the input and output shafts of the transmission and the fixed structures, such as the transmission casing) may be used, and the disclosure is not limited to the exemplary arrangement of FIG. 2. For example, where the transmission 30 has a star arrangement (described above), a person skilled in the art will readily understand that the arrangement of output and support linkages and bearing positions would usually be different than that shown by way of example in FIG. 2.

Accordingly, the present disclosure extends to a gas turbine engine having an arbitrary arrangement of transmission types (for example star-shaped or planetary), support structures, input and output shaft arrangement, and bearing positions.

Optionally, the transmission may drive additional and/or alternative components (e.g. the intermediate-pressure compressor and/or a booster compressor).

Other gas turbine engines in which the present disclosure can be used may have alternative configurations. For example, such engines may have an alternative number of compressors and/or turbines and/or an alternative number of connecting shafts. By way of further example, the gas turbine engine shown in FIG. 1 has a split flow nozzle 20, 22, meaning that the flow through the bypass duct 22 has a dedicated nozzle that is separate from and radially outside the engine core nozzle 20. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable region. Although the example described relates to a turbofan engine, the disclosure can be applied, for example, to any type of gas turbine engine, such as, for example, an open rotor engine (in which the fan stage is not surrounded by an engine nacelle) or a turboprop engine.

The geometry of the gas turbine engine 10, and components thereof, is or are defined using a conventional axis system which comprises an axial direction (which is aligned with the axis of rotation 9), a radial direction (in the direction from bottom to top in FIG. 1), and a circumferential direction (perpendicular to the view in FIG. 1). The axial, radial and circumferential directions run so as to be mutually perpendicular.

FIG. 3 and FIG. 4 show an orientation of the transmission 30 in its installation position in the gas turbine engine 10 during a horizontal flight of an aircraft equipped with a gas turbine engine 10. The rotatable planet carrier 34 of the transmission 30 is formed with a rotationally symmetrical channel 41, 141 on both its side facing the shaft 26 and on its side facing away from the shaft 26, in the manner shown in more detail in FIG. 3 and FIG. 4. The channels 41, 141 are arranged coaxially to the rotational axis of the planet carrier 34 and sun gear 28, and in radially inner regions 42, 142 are each configured with an opening extending in the circumferential direction of the channel 41, 141. Starting from mutually corresponding radial inner diameters Di41, Di141 of the channels 41, 141, oil can be conducted out of oil supplies 44, 144 fixed to the housing, through the openings 43, 143, into the channels 41, 141 which have approximately the same channel width.

Infeed directions E, E100 of the oil into the channels 41, 141, starting from the oil supplies 44, 144, each run parallel to an xy plane and thus enclose an angle α equal to 90° with the axial extent direction z of the channels 41, 141. With an angle α of 90°, oil is introduced into the channels 41, 141 in the y direction, i.e. radially outward. Furthermore, the infeed directions E, E100 of the oil into the channels 41, 141 intersect a yz plane and, depending on the respective application, enclose an angle β with the radial extent direction y which is greater than or equal to 0° and less than 90°. Here, with an angular value of the angle β which is equal to 90°, the oil is introduced tangentially into the channels 41, 141 and in the rotational direction of the channels 41, 141. In contrast, the infeed directions E, E100 are the same as the y direction when the angle β is equal to 0°.

Alternatively, it is also possible that, as shown in more detail in FIG. 4, the infeed directions E′, E100′ of the oil into the channels 41, 141, starting from the oil supplies 44′, 144′, each enclose an angle α′ between 45° and 135°, preferably between 75° and 90° or between 80° and 90°, with the axial extent direction z of the channels 41, 141.

In order to be able to guide the oil introduced into the channels 41, 141, out of the channels 41, 141, for example in the region of the bearing of the planet gears 32, the channels 41, 141 each have a plurality of outlet openings 46, 146 for the oil arranged in a radially outer region 45, 145 and distributed over the periphery of the channels 41, 141. The oil, which is conducted into the channels 41, 141 via the oil supplies 44, 144 with a desired impulse and then, in addition to the applied impulse, is accelerated outwards in the radial direction y by the centrifugal force acting on the oil in the channels 41, 141 as the planet carrier 34 rotates, can initially be conducted out of the channels 41, 141 via the outlet openings 46, 146. From there, the oil is transferred in the axial direction z of the transmission 30 via line regions 47, 147 of the planet carrier 34. The line regions 47, 147 have stub lines 48, 148 running radially to the outside in the y direction, the opening regions 49, 149 of which each lie in the region of hydraulic consumers in the planetary gear mechanism, such as bearings of the planet gears 32.

It is possible here that the radial distances R49, R149 between the opening regions 49, 149 and a rotational axis 70 of the planet carrier 34 are each larger than radial distances between the outlet openings 46, 146 of the channels 41, 141 and the rotational axis 70. Then oil introduced into the respective channels 41, 141 is also accelerated downstream of the outlet openings 46, 146 up to the opening regions 49, 149 by the centrifugal force acting during operation, or is conveyed through the channels 41, 141, the line regions 47, 147 and the stub lines 48, 148 to the respective hydraulic consumers to be supplied.

The radial distance between the outlet openings 46, 146 of the channels 41, 141 and the rotational axis 70 in the present exemplary embodiments amounts to half an outer diameter Da41, Da141 of the channels 41, 141 in each case.

Furthermore, it may also be provided that the radial distances R49, R149 between the opening regions 49, 149 and the rotational axis 70 of the planet carrier 34 each correspond to or are smaller than the radial distances between the outlet openings 46, 146 of the channels 41, 141 and the rotational axis 70.

The oil supplies 44, 144 each comprise an oil nozzle 50, 150. Outlet openings 51, 151 of the oil nozzles 50, 150 are arranged spaced apart from the openings 43, 143 of the channels 41, 141 in the y direction or radial direction. The oil is expelled from the oil nozzles 50, 150 with defined supply pressure, and depending on the design of the outlet openings 51, 151 of the oil nozzles 50, 150, is injected or sprayed into the channels 41, 141 with such an impulse that the oil in the channels 41, 141 flows, starting from the openings 43, 143 of the channels 41, 141, substantially in the y direction or substantially radially outward to the outlet openings 46, 146 of the channels 41, 141. The aim is that oil is conducted via the outlet openings 46, 146 of the channels 41, 141 into the line regions 47, 147 with a flow speed which guarantees a desired oil supply to the bearings of the planet gears 32.

In the exemplary embodiment of the transmission 30 shown in FIG. 3 and FIG. 4, and oil nozzle 50, 150 is assigned to each channel 41, 141. Furthermore, the oil supplies 44, 144 may each comprise several oil nozzles 50, 150.

The oil nozzles arranged radially inside the channels 41, 141 may be positioned centrally, in the axial extent direction of the channels 41, 141, between the regions delimiting the channels 41, 141 in the axial direction. Then the introduced oil is conducted as evenly as possible over the axial width of the channels 41, 141.

Alternatively or additionally, the sun gear, planet gears and/or ring gear may be equipped with a channel in the fashion described above, into which oil can be conducted via a corresponding oil supply, in order to supply oil to hydraulic consumers in the transmission 30.

FIG. 5 shows an illustration corresponding to FIG. 4 of a further embodiment of the transmission 30, which corresponds substantially to the embodiment described in FIG. 4. For this reason, only the differences between the two embodiments are described in detail below. With respect to the fundamental function of the embodiment of the transmission 30 shown in FIG. 5, reference is made to the description relating to FIG. 4.

In the embodiment of the transmission 30 according to FIG. 5, the outer diameters Da41 and Da141 of the channels 41, 141 are equal. Furthermore, the inner diameter Di41 of the channel 41 is greater than the inner diameter Di141 of the channel 141, whereby a channel depth T141 of the channel 141 is greater than a channel depth T41 of the channel 41. Furthermore, the radial distances R49, R149 of the opening regions 49, 149 from the rotational axis 70 are the same. This gives the possibility that in operation of the transmission 30, if for example the same oil volume flow is introduced into the channels 41 and 141 from the oil supplies 44 and 144, a greater oil column will be set in the channel 141 and the respective hydraulic consumer will be loaded with a greater oil volume flow from the channel 141 than from the channel 41. This is the case for example if the oil volume flow supplied to the channels 41 and 141 is so large that the channel 41 overflows. Then only part of the oil volume flow supplied to the channel 41 is conducted in the direction of the opening regions 49, while the further part of the supplied oil volume flow flows out of the channel 41 over the inner edge of the channel 41 which is completely filled with oil, and is flung radially outward outside of the channel 41.

In an illustration corresponding to FIG. 4, FIG. 6 shows a further exemplary embodiment of the transmission 30, the function of which again corresponds substantially to the function of the transmission 30 from FIG. 4. The transmission 30 in FIG. 6 differs from the transmission 30 in FIG. 4 substantially only in that the two channels 41, 141 are arranged on the side of the planet carrier 34 facing the shaft 26, and the channel depth T141 of the channel 141 is smaller than the channel depth T41 of the channel 41. This is the case because the inner diameter Di141 of the channel 141 is greater than the inner diameter Di41 of the channel 41. In addition, the channel depths T141 and T41 differ from one another also because an outer diameter Da141 of the channel 141 is smaller than an outer diameter Da41 of the channel 41. The radial distances R49, R149 of the opening regions 49, 149 from the rotational axis 70 again correspond to one another.

FIG. 7 shows a first embodiment of an oil system 55 of the gas turbine engine 10. The oil system 55 comprises a first oil circuit 56 and a second oil circuit 57. The first oil circuit 56 and the second oil circuit 57 are fluidically coupled to a common output 59 of the transmission 30. Furthermore, the first oil circuit 56 and the second oil circuit 45 are each fluidically coupled to a separate inlet 61 and 62 of the transmission 30. The first oil circuit 56 and the second oil circuit 57 are each formed with a pump 62, 63 which is driven by the core shaft 26 or core shaft 27 respectively.

The outlet 59 of the transmission 30 comprises a device 64 which is designed to conduct oil from the transmission 30 into the first circuit 56 and the second oil circuit 57.

FIG. 8 shows a second embodiment of the oil system 55 of the gas turbine engine 10. The oil system 55 comprises the first oil circuit 56, the second oil circuit 57 and a third oil circuit 65. The first oil circuit 56, the second oil circuit 57 and the third oil circuit 65 are all fluidically actively connected to the output 59 of the transmission 30. Furthermore, the first oil circuit 56, the second oil circuit 57 and the third oil circuit 65 are each fluidically coupled to a separate inlet 60, 61, 66 of the transmission 30.

The first oil circuit 56 and the second oil circuit 57 each comprise a respective pump 62 and 63. In addition, the third oil circuit 65 is equipped with a pump 67 which is driven by the fan 23 or the core shaft 27, or by another suitable drive unit, e.g. an electric drive unit or similar. Oil is conducted from the outlet 59 of the transmission 30, again via the device 64, into the first oil circuit 56, the second oil circuit 57 and also the third oil circuit 65.

It will be understood that the invention is not limited to the embodiments described above, and various modifications and improvements can be made without departing from the concepts described herein. Any of the features may be used separately or in combination with any other features, unless they are mutually exclusive, and the disclosure extends to and includes all combinations and subcombinations of one or more features which are described here.

### LIST OF REFERENCE SIGNS

9 Main axis of rotation
10 Gas turbine engine
11 Core
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Thrust fan
24 Support structure
26 Shaft, connecting shaft
27 Connecting shaft
28 Sun gear
30 Transmission, planetary gear mechanism
32 Planet gear
34 Planet carrier
36 Linkage
38 Ring gear
40 Linkage
41, 141 Channel
42, 142 Radially inner region of channel
43, 143 Opening
44, 144 Oil supply
45, 145 Radially outer region of channel
46, 146 Outlet opening
47, 147 Line region
48, 148 Stub line
49, 149 Opening region
50, 150 Oil nozzle
51, 151 Outlet opening
55 Oil system
56 First oil circuit
57 Second oil circuit
59 Outlet
60, 61 Inlet
62, 63 Pump
64 Device
65 Third oil circuit
66 Inlet
67 Pump
68 Valve unit
69 Duct
70 Rotational axis
A Core air flow
B Bypass air flow
Di Inner diameter of channels
Da Outer diameter of channels
E Infeed direction
R49, R149 Radial distance
T41, T141 Channel depth
α, α′ Angle
β, β′ Angle

1. A transmission (30) with a rotatably mounted component (34),
which is designed with at least two approximately rotationally symmetrical channels (41, 141),
into each of which oil from a respective oil supply (44, 144) fixed to the housing can be introduced, starting from the radially inner region (42, 142) of said channels,
wherein in at least one radially outer region (45, 145), the channels (41, 141) each have at least one outlet opening (46, 146) for the oil,
and wherein the oil can be conveyed from the outlet openings (46, 146) to at least one hydraulic consumer via at least one respective line region (47, 147).

2. The transmission as claimed in claim 1, characterized in that supply line cross-sections of the oil supplies (44, 144) correspond to one another.

3. The transmission as claimed in claim 1, characterized in that supply line cross-sections of the oil supplies (44, 144) differ from one another.

4. The transmission as claimed in any of claims 1 to 3, characterized in that radial depths (T41, T141) of the channels (41, 141) differ from one another.

5. The transmission as claimed in any of claims 1 to 3, characterized in that radial depths (T41, T141) of the channels (41, 141) correspond to one another.

6. The transmission as claimed in any of claims 1 to 5, characterized in that cross-sections of the line regions (47, 147) correspond to one another.

7. The transmission as claimed in any of claims 1 to 5, characterized in that cross-sections of the line regions (47, 147) differ from one another.

8. The transmission as claimed in any of claims 1 to 7, characterized in that the line regions (47, 147) comprise opening regions (49, 149) which are each arranged in the region of hydraulic consumers in the planetary gear mechanism, and via which the hydraulic consumers can be loaded with oil.

9. The transmission as claimed in claim 8, characterized in that radial distances (R49, R149) between the opening regions (49, 149) and a rotational axis (70) of the component (34) are each larger and/or smaller than radial distances between the outlet openings (46, 146) of the channels (41, 141) and the rotational axis (70), or the radial distances (R49, 149) between the opening regions (49, 149) and the rotational axis (70) of the component (34) are the same as the radial distances between the outlet openings (46, 146) of the channels (41, 141) and the rotational axis (70).

10. The transmission as claimed in any of claims 1 to 9, characterized in that the channels (41, 141) are arranged on the same side of the component (34).

11. The transmission as claimed in any of claims 1 to 9, characterized in that at least one of the channels (41) is arranged on one side of the component (34), and at least a further one of the channels (141) is arranged on the side opposite thereto in the axial extent of the component (34).

12. The transmission as claimed in any of claims 1 to 11, characterized in that infeed directions (E, E100; E′, E100′) of the oil into the channels (41, 141), starting from the oil supplies (44, 144; 44′, 144′), each enclose an angle (α′) between 45° and 135° with the axial extent direction (z) of the channels (41, 141), while the infeed directions (E, E100; E′, E100′) of the oil in the circumferential direction of the channels (41, 141) each enclose an angle (β) with the radial extent direction (y) which is greater than or equal to 0° and less than 90°.

13. The transmission as claimed in any of claims 1 to 11, characterized in that the infeed directions (E′, E100′) of the oil into the channels (41, 141), starting from the oil supplies (44′, 144′), each enclose an angle (α′) between 75° and 90°, preferably between 80° and 90°, with the axial extent direction (z) of the channels (41, 141).

14. The transmission as claimed in any of claims 1 to 13, characterized in that oil can be conducted out of the channels (41, 141) via the outlet openings (46, 146) in the direction of the bearing and/or a toothing.

15. The transmission as claimed in any of claims 1 to 14, characterized in that the component (34) is a rotating shaft, preferably a sun gear (28), a planet carrier, a planet gear (32) and/or a ring gear (38).

16. A gas turbine engine (10) for an aircraft, comprising the following:
an engine core (11) which comprises a turbine (19), a compressor (14), and a core shaft (26) that connects the turbine (19) to the compressor (14);
a fan (23) which is positioned upstream of the engine core (11), wherein the fan (23) comprises multiple fan blades; and
a transmission (30), which receives an input from the core shaft (26) and outputs drive for the fan (23) in order to drive the fan (23) at a lower speed than the core shaft (26), wherein the transmission (30) is configured as a planetary gear mechanism as claimed in any of claims 1 to 15.

17. The gas turbine engine as claimed in claim 16, characterized in that the turbine is a first turbine (19), the compressor is a first compressor (14), and the core shaft is a first core shaft (26);
the engine core (11) furthermore comprises a second turbine (17), a second compressor (15) and a second core shaft (27) which connects the second turbine (17) to the second compressor (15); and
the second turbine (17), the second compressor (15) and the second core shaft (27) are arranged so as to rotate at a higher rotational speed than the first core shaft (26).
